(19) United States
(12) Patent Application Publication
(10) Pub. No.: US 2026/0203142 A1
(43) Pub. Date: Jul. 16, 2026

(54) CURATING A PERSONALIZED IMAGE BASED PUSH NOTIFICATION

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/017,305

(22) Filed: Jan. 10, 2025

(51) Int. Cl. G06F 9/54; G06F 16/9535; G06F 16/9538

(52) U.S. Cl. CPC G06F 9/542; G06F 16/9535; G06F 16/9538

(57) ABSTRACT

An electronic device curates push notifications to align with user interests to provide a better user experience. The electronic device has a memory including a personal knowledge base that contains user interest subject(s) and a curated push notification module. The electronic device has a communications subsystem that links the electronic device to a push notification source. A processor of the electronic device is communicatively coupled to the memory and the communications subsystem. The processor is configured to cause the electronic device to receive, via the communications subsystem from the push notification source, push notification(s) including a first push notification. The processor matches user interest subject(s) to notification content contained in the first push notification. The processor generates a personalized push notification including at least a portion of the first push notification and a notification image that corresponds to the user interest(s) that is matched to the notification content.

### BACKGROUND

### 1. Technical Field

The present disclosure relates generally to electronic devices that receive content from a network source, and more particularly to electronic devices that receive content and present the content via an output device for user consumption.

### 2. Description of the Related Art

Electronic communication devices such as smartphones, tables, laptops, and desktop workstations are operated by users for a myriad of functions such as office automation, communication and entertainment. Providers of electronic devices and service providers to electronic devices often have content that may be of interest to the users. The content may be about the electronic device and services or be provided on behalf of other entities such as advertisers and content producers.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 illustrates a block diagram of a curated push notification module of the electronic device configured to curate push notifications to align with user interests to provide a better user experience, according to one or more embodiments;

FIG. 3 illustrates a software platform diagram of an example artificial intelligence (AI) operating system (OS) of the electronic device that learns about a user of the electronic device, according to one or more embodiments;

FIG. 4 illustrates a first example promoted content describing a soccer game, according to one or more embodiments;

FIG. 5A illustrates an original non-curated push notification based on the first example promoted content of FIG. 4, according to one or more embodiments;

FIG. 5B illustrates a first curated push notification based on the first example promoted content of FIG. 4 and interests of a first user, according to one or more embodiments;

FIG. 5C illustrates a second curated push notification based on the first example promoted content of FIG. 4 and interests of a second user, according to one or more embodiments;

FIG. 6 illustrates a second example promoted content describing an updated mobile device, according to one or more embodiments;

FIG. 7A illustrates an original non-curated push notification based on the second example promoted content of FIG. 6, according to one or more embodiments;

FIG. 7B illustrates a third curated push notification based on the second example promoted content of FIG. 4 and interests of a third user, according to one or more embodiments;

FIG. 7C illustrates a fourth curated push notification based on the second example promoted content of FIG. 6 and interests of a fourth user, according to one or more embodiments; and

FIGS. 8A-8B (collectively “FIG. 8”) are a flow diagram presenting a computer-implemented method for curating/personalizing push notifications presented by an electronic device to align with user interests to provide a better user experience, according to one or more embodiments.

### DETAILED DESCRIPTION

According to aspects of the present disclosure, an electronic device, a method and a computer program product provide various techniques for curating push notifications presented by an electronic device to align with interests of the device user to provide a better user experience.

Currently available push notifications that are not curated specifically for user interests may cover a broad range of topics. In an example, push notifications may inform a user of new features of their user device, breaking news, recent sports events, entertainment offerings, etc. Highlights from the full content are visually and textually presented on a user device inviting user selection to view the entirety of the content. The highlights selected for the push notification are presented to a broad population of users of respective user devices. With limited information being highlighted in the push notification, an opportunity may be missed to alert a user who has a particular interest in the content that is not highlighted.

The present disclosure provides techniques for curating push notifications by the electronic device with personalized highlights (e.g., images, text) that are specific to a user of the electronic device. In one or more embodiments, the electronic device learns about user interests by monitoring user selections and activities, capturing user interests and preferences in a personal knowledge base (PKB). When the electronic device receives promoted content (e.g., news article, advertisement, a match report) from a network source that is suitable for a push notification or is pre-packaged as a push notification, the electronic device begins a curated push notification process. The electronic device analyzes the promoted content to determine key aspects (e.g., topics, entities, locations) using various natural language processing (NLP) techniques. The electronic device matches the identified aspects of the content with user's interest and preferences from existing profiles, such as contained in the PKB, to determine the most relevant/dominant aspects of the promoted content. In some instances, the electronic device does not find user in the promoted content and processing for as a curated push notification is discontinued. The electronic device generates a personalized image and/or text that may be of interest to the user based on matched user interests and content aspects. The electronic device renders/assembles the new curated push notification with the personalized image and/or text. The electronic device presents curated “personalized” push notification to the user via one or more output devices.

According to one or more embodiments, an electronic device has a memory including (i) a personal knowledge base comprising one or more user interest subject; and (ii) a curated push notification module. The electronic device includes a communications subsystem that links the electronic device to a push notification source. A processor of the electronic device is communicatively coupled to the memory and the communications subsystem. The processor is configured to cause the electronic device to receive, via the communications subsystem from the push notification source, one or more push notification, including a first push notification. The processor is configured to cause the electronic device to match at least one user interest subject of the one or more user interest subject in the personal knowledge base to notification content contained in the first push notification. The processor is configured to cause the electronic device to generate a personalized push notification including at least a portion of the first push notification and a notification image that corresponds to the at least one user interest that is matched to the notification content.

According to one or more embodiments, a computer-implemented method is provided for curating push notifications presented by an electronic device to align with user interests to provide a better user experience. The method includes receiving, via a communications subsystem of an electronic device from a push notification source, one or more push notification, including a first push notification. The method includes matching at least one user interest subject of one or more user interest subject in a personal knowledge base, which is stored in memory of the electronic device, to notification content contained in the first push notification. The method includes generating a personalized push notification comprising at least a portion of the first push notification and a notification image that corresponds to the at least one user interest that is matched to the notification content.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

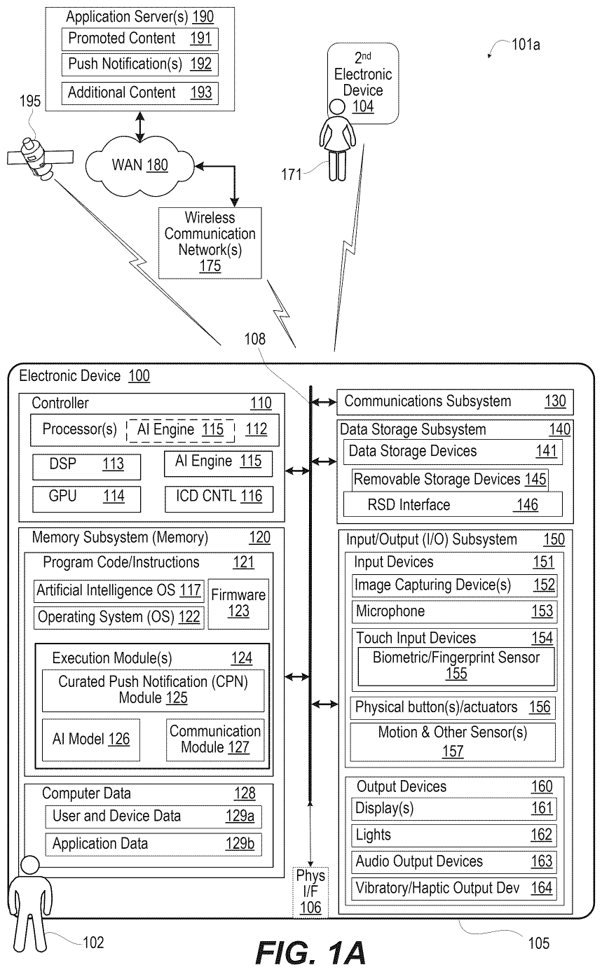

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 curates/personalizes push notifications presented by electronic device 100 to align with user interests of user 102 to provide a better user experience. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

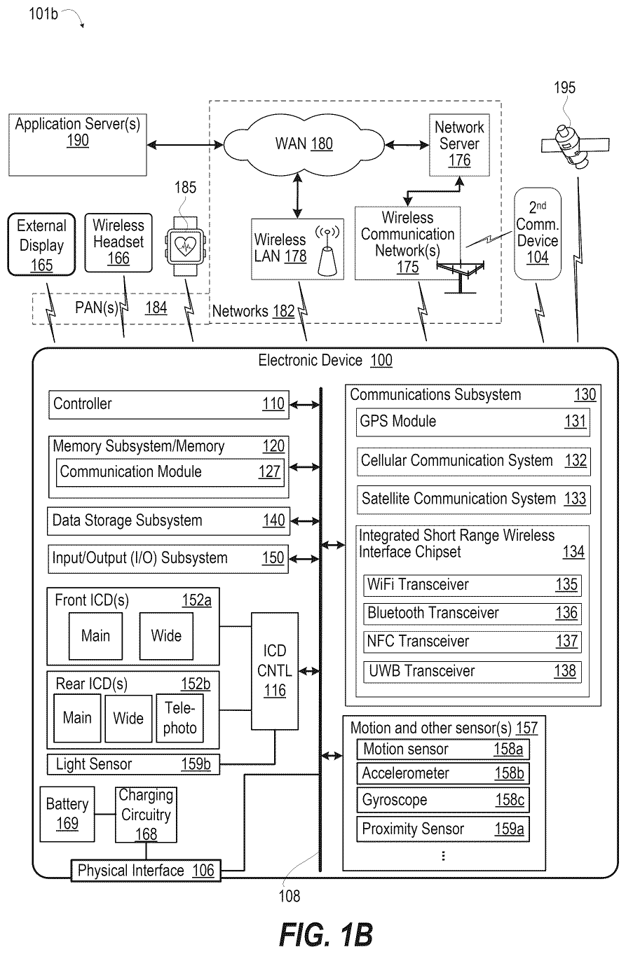

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that is described below with regard to FIG. 2.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, curated push notification (CPN) module 125, which provides the features and operating functionality of the disclosed embodiments when the corresponding program instructions of CPN module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CPN module 125 and is trained to support the AI features of CPN module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CPN module 125 can include program instructions that cause or configure processor 112 to cause electronic device 100 to curate push notifications based on analyzing proposed content against known user interest(s). Other features provided by CPN module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CPN module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 171 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CPN module 125 and/or access to other applications, online transactions, and resources. Application servers 190 may provide a push notification source for promoted content 191, push notifications 192 linked respectively to promoted content 191, and additional content 193 such as images related to promoted content 191.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

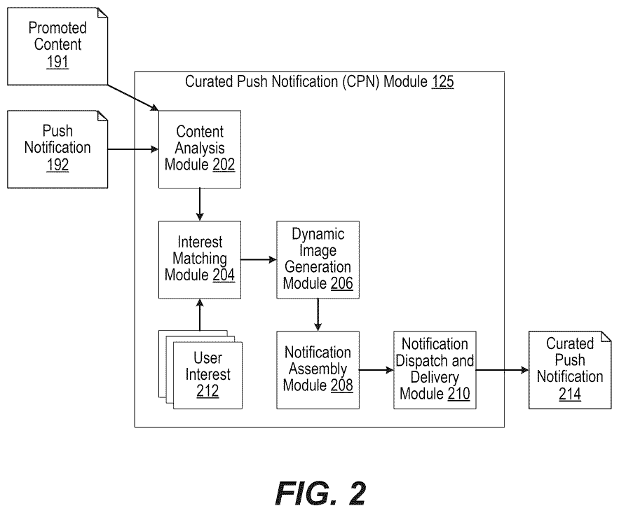

FIG. 2 illustrates a block diagram of curated push notification (CPN) module 125 of electronic device 100 (FIG. 1A) configured to curate/personalize push notifications to align with user interests to provide a better user experience. Example CPN module 125 includes content analysis module 202, interest matching module 204, dynamic image generation module 206, notification assembly module 208, and notification dispatch and delivery module 210. Content analysis module 202 receives push notification 192 that is generic and not specifically tailored or personalized. The push notification 192 links to promoted content 191. In one or more other embodiments, CPN module 125 may receive or download promoted content 191 without having received push notification 192. Content analysis module 202 analyzes the promoted content 191 to identify what subjects (separately identifiable/distinguishable topics, categories, content, persons, etc.) are included within promoted content 191. Content analysis module 202 communicates the analyzed subjects as well as promoted content 191 and push notification 192 to interest matching module 204. Interest matching module 204 compares user interests 212, such as stored in personal knowledge base 334 (FIG. 3), to the analyzed subjects to find matched subjects to pass to dynamic image generation module 206. Dynamic image generation module 206 locates image(s) within promoted content 191 and/or from other sources (e.g., stock images, additional content 193 from applicant server(s) 190). For more than one image, in some embodiments, dynamic image generation module 206 stitches together the more than one image into a push notification image. CPN module 125 passes control to notification assembly module 208 to bring together the push notification image and highlight text aligned with the matched interest into curated push notification 214 that is routed by notification dispatch and delivery module 210 to one or more output devices to present to user 102 of electronic device 100 (FIG. 1A).

FIG. 3 illustrates a software platform diagram of an example artificial intelligence (AI) operating system (OS) 117. By learning about the user, AI OS 117 can anticipate future actions of the user and provide recommendations for the user, improving user experience. AI OS 117 supports functionality of CPN module 125 (FIG. 1A) that adds functionality for learning user interests and using the learned user interest to curate push notifications for promoted content. AI OS 117 includes user plane 302 supported by control plane 304. User plane includes AI user interface (UI) 306 that supports contextual user experience (UX) component 308, ambient UX component 310, and prompt UX component 312. Control plane 304 includes AI agents 314 that communicate via grounding component 316 to local arbitration orchestration component 318 having local models 320 and cloud models 322. AI agents 314 communicates via grounding component 316 to web interface 324. AI agents 314 includes hero experiences agent 326, cross-device intelligence agent 328, large action model 330, future timeline 332, personal knowledge base 334, context sensing engine 336, and recommendation engine 338.

User experience (UX) design is defined as a multidisciplinary field that focuses on enhancing the overall experience that individuals have when interacting with a digital product, system, or service. UX design encompasses various aspects of user interaction, including usability, accessibility, aesthetics, and overall satisfaction. UX design aims to create meaningful and positive experiences for users by understanding their needs, behaviors, and preferences.

Grounding component 316 in AI is an essential process that ensures AI systems comprehend and interact with the real world accurately. Grounding is a bridge between abstract AI concepts and practical, tangible outcomes. Grounding allows AI systems to bridge semantic gaps in the real world, team with other agents in such environments, process inputs from the environment, and learn from interactions. A successful synthetic teammate requires several cognitive capacities, including situation assessment, task behavior, language comprehension and generation, and knowledge gap resolution processes. Grounding enables agents with different capabilities to communicate.

With particular reference to FIG. 1A, according to aspects of the present disclosure, electronic device 100 has memory including: (i) a personal knowledge base 334 (FIG. 3) having one or more user interest subject; and (ii) a curated push notification module. Electronic device 100 includes communications subsystem 130 that links electronic device 100 to a push notification source (e.g., application servers 190). Processor 112 is communicatively coupled to memory 120 and communications subsystem 130. Processor 112 is configured to cause electronic device 100 to receive, via communications subsystem 130 from the push notification source, one or more push notification 192, including a first push notification. Processor 112 is configured to cause electronic device 100 to match at least one user interest subject of the one or more user interest subject in the personal knowledge base 334 (FIG. 3) to notification content (e.g., promoted content 191) contained in the first push notification. Processor 112 is configured to cause electronic device 100 to generate a personalized curated push notification 214 (FIG. 2) including at least a portion of the first push notification (192) and a push notification image that corresponds to the at least one user interest 212 (FIG. 2) that is matched to the notification content. In one or more embodiments, curated push notification (CPN) module 125 includes an artificial intelligence (AI) engine 115 trained to match a current interest to a notification content.

In one or more embodiments, electronic device 100 includes at least one output device 160 communicatively coupled to processor 112. Processor 112 is further configured to cause electronic device 100 to present the personalized curated push notification 214 (FIG. 2) via at least one output device 160 in lieu of the first push notification. In one or more embodiments, processor 112 is further configured to discard a second push notification of the one or more push notification that does not include notification content matching the at least one user interest subject. In one or more embodiments, processor 112 is further configured to cause electronic device 100 to match the one or more user interest subject from a group of user interest subjects including: (i) a person; (ii) an organization; (iii) a place; (iv) an object; (v) an activity; and (vi) an event.

In one or more embodiments, processor 112 is further configured to cause electronic device 100 to search one or more network source (e.g., applicant servers 190) for the image, based on a query associated with the match of the one or more user interest and the notification content. Processor 112 is further configured to cause electronic device 100 to download the image identified by the search.

In one or more embodiments, in response to determining that more than one current user interest matches respective one or more notification content, processor 112 is further configured to cause electronic device 100 to search one or more network source (e.g., applicant servers 190) for more than one image corresponding to the more than one current interest. Processor 112 is further configured to cause electronic device 100 to stitch together the more than one image into the notification image.

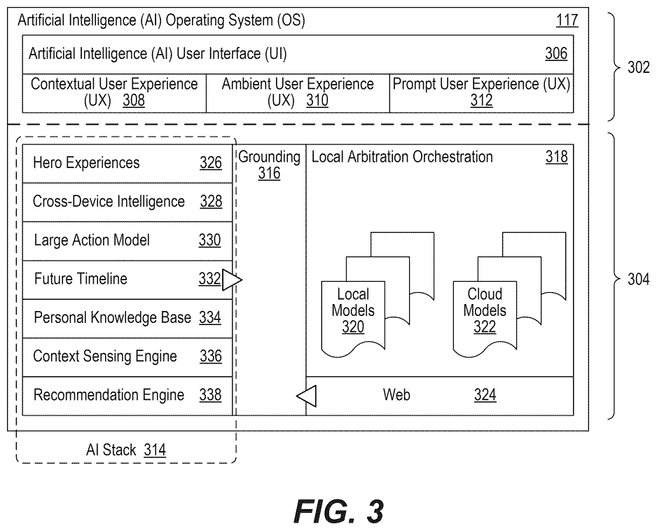

FIG. 4 illustrates a first example promoted content 191a describing a soccer game. Promoted content 191a may include images such as Maineville Lion logo 402 and Smithton Tornadoes logo 404. Analysis of promoted content 191a may also identify textual highlights such as “Elite League: Maineville Lions—Smithton Tornadoes played sensational 4 -4 draw (February 16)”, “Bob Jones scores late penalty”, “Smithton salvaged the draw”, Scott Williams scores a 50-yard stunner”, and “Visitors title hopes dented by Maineville”. User 102 (FIG. 1A) may be interested generally in the sport, in one or both teams, and/or one or both players mentioned in the promoted content 191. Other users would have corresponding personal interests that may differ at least in part.

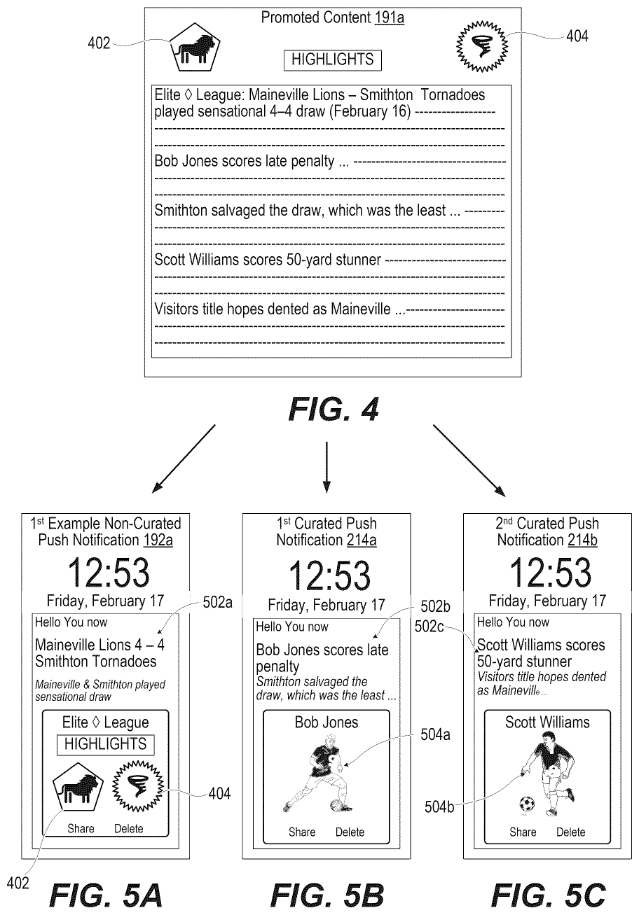

FIG. 5A illustrates first non-curated/generalized push notification 192a based on first example promoted content 191a of FIG. 4. To appeal to a broad general population, non-curated/generalized push notification 192a includes Maineville Lion logo 402 and Smithton Tornadoes logo 404 and textual highlight 502a derived from the title of first example promoted content 191a of FIG. 4. In an example, some users may be a fan of one or both teams and be motivated to interact with non-curated/generalized push notification 192a. However, other users may not be a fan of either team. The other users may have instead an unrealized interest in the first example promoted content 191 of FIG. 4 that is not highlighted by non-curated/generalized push notification 192a. An opportunity is missed for enhancing user experience via electronic device 100 (FIG. 1A) by curating/personalizing a push notification such as described below with regard to FIGS. 5B-5C .

FIG. 5B illustrates first curated/personalized push notification 214a based on the first example promoted content 191a of FIG. 4 and interests of a first user, such as user 102 (FIG. 1A). In analyzing user interests of the first user, electronic device 100 recognizes specific interest in player Bob Jones throughout his career, which may include multiple teams as well as side activities. The first user may not be particularly interested in the teams that played yesterday. In response to the identified user interest, first curated/personalized push notification 214a is customized for the first user by identifying first personalized textual heading 502b directed to play of Bob Jones. First personalized image 504a is located within first example promoted content 191a of FIG. 4 or other image repositories and included in first curated/personalized push notification 214a.

FIG. 5C illustrates a second curated/personalized push notification 214b based on the first example promoted content of FIG. 4 and interests of a second user. In analyzing user interests of the second user, electronic device 100 recognizes specific interest in another player, Scott Williams from recent online searches or from YouTube/Instagram content viewing. The second user may not be particularly interested in the teams that played yesterday. In response to the identified second user interest in Scott Williams, second curated/personalized push notification 214a is customized for the second user by identifying second personalized textual heading 502c directed to the play of Scott Williams. Second personalized image 504b is located within first example promoted content 191a of FIG. 4 or other image repositories and included in second curated/personalized push notification 214b.

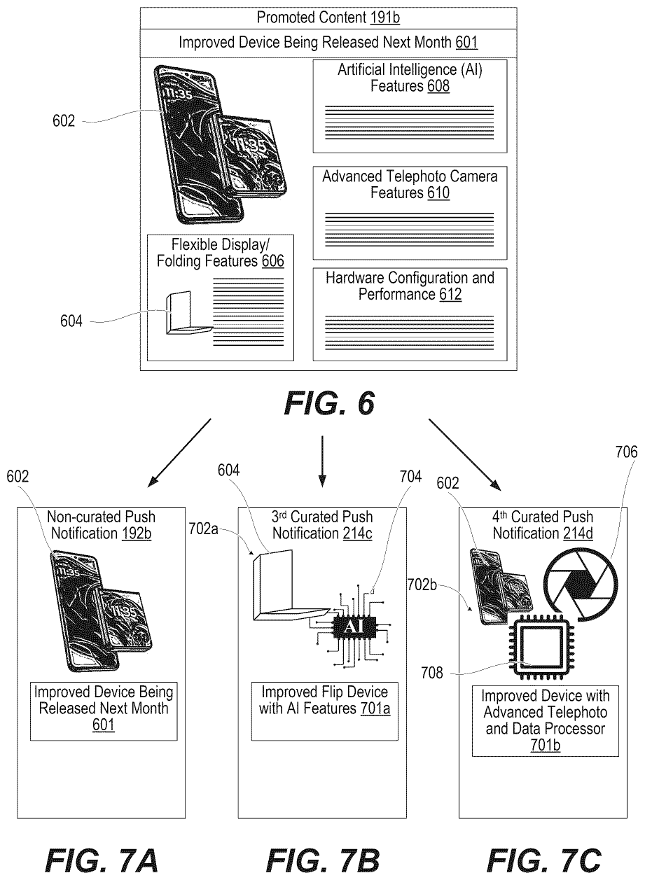

FIG. 6 illustrates a second example promoted content 191b with title 601 describing an updated mobile device release. Promoted content 191b may include images such as extended and retracted positioned device image 602 and laptop/tent positioned device image 604. Analysis of promoted content 191b may also identify textual highlights including flexible display/folding features 606, artificial intelligence features 608, advanced telephoto camera features 610, and hardware configuration and performance features 612.

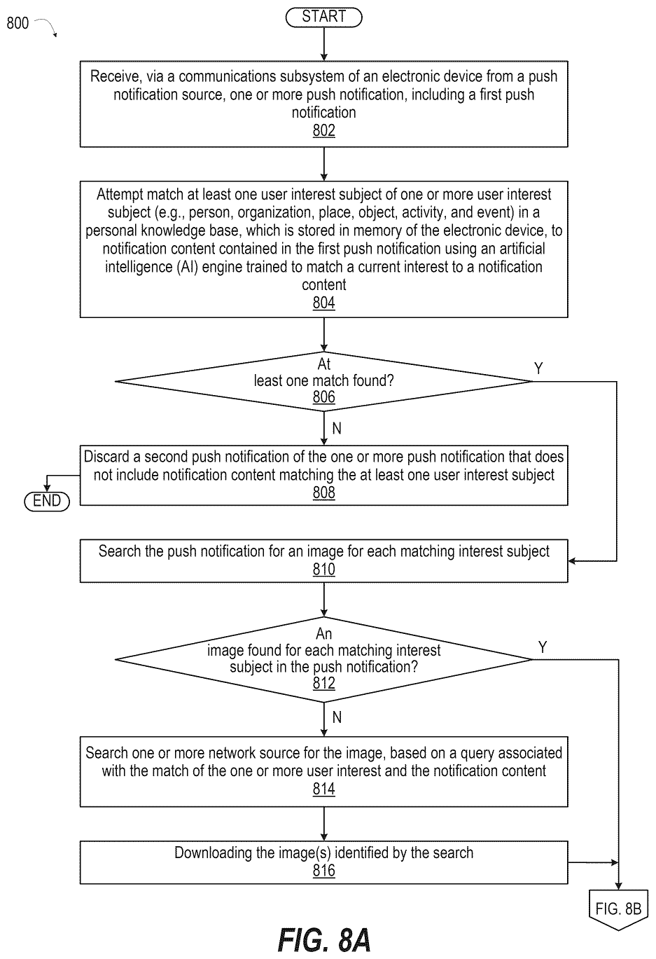

FIG. 7A illustrates second example non-curated/generalized push notification 192b based on second example promoted content 191b of FIG. 6 that includes title 601 and emphasized image (e.g., as extended and retracted positioned device image 602). Some individuals may be interested based on merely seeing that an update is being released. However, other users unfamiliar with the particular product line may not realize interest in this second example promoted content 191b of FIG. 6 about the updated device without highlighting particular technical features that are of specific interest to the individuals.

FIG. 7B illustrates a third curated/personalized push notification 214c based on second example promoted content 191b of FIG. 4 and interests of a third user. Based on analyzing second example promoted content 191b of FIG. 6 and user interests of third user in hands-free flip phone use and AI, third curated/personalized push notification 214c is generated and includes personalized heading 701a that covers two topics: improved flip positioning with AI features. Stitched together image 702a is assembled from laptop/tent positioned device image 604 from promoted content 191b (FIG. 6) and AI icon image 704 located in stock or remote image repositories.

FIG. 7C illustrates a fourth curated/personalized push notification 214d based on second example promoted content 191b of FIG. 6 and interests of a fourth user. Based on analyzing second example promoted content 191b of FIG. 6 and user interests of fourth user in telephoto camera and advanced processors, fourth curated/personalized push notification 214d is generated and includes personalized heading 701b that covers the two topics: improved device with advanced telephoto and data processor features. Stitched together image 702b is assembled from extended and retracted positioned device image 602 from promoted content 191b (FIG. 6) with telephoto icon image 706 and processor icon image 708 retrieved from stock or remote image repositories.

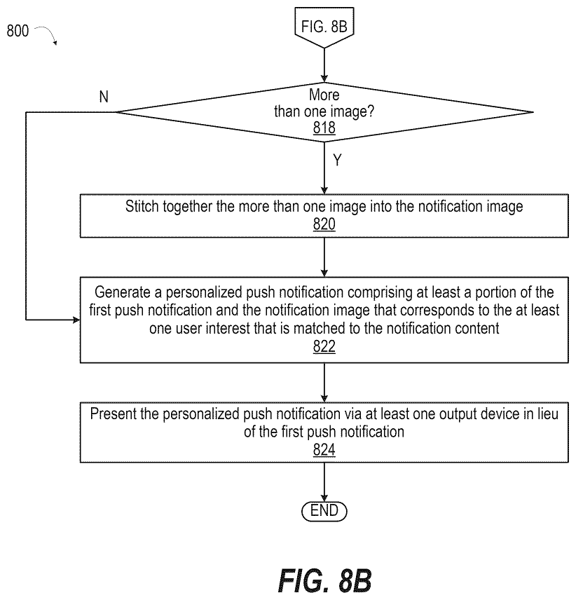

FIGS. 8A-8B (collectively “FIG. 8”) are a flow diagram presenting computer-implemented method 800 for curating/personalizing push notifications presented by an electronic device to align with user interests to provide a better user experience. The description of method 800 (FIG. 8) is provided with general reference to the specific components illustrated within the preceding FIGS. 1A-1B, 2-4, 5A-5C, 6 and 7A-7C . Specific components referenced in method 800 (FIG. 8) may be identical or similar to components of the same name used in describing preceding FIGS. 1A-1B, 2-4, 5A-5C, 6 and 7A-7C . In one or more embodiments, controller 110 (FIG. 1A) configures electronic device 100 (FIGS. 1A-1B) or a similar computing device to provide the described functionality of method 800 (FIG. 8).

With reference to FIG. 8A, method 800 includes receiving, via a communications subsystem of an electronic device from a push notification source, one or more push notification, including a first push notification (block 802). Method 800 includes matching at least one user interest subject of one or more user interest subject (e.g., person, organization, place, object, activity, and event) in a personal knowledge base, which is stored in memory of the electronic device, to notification content contained in the first push notification using an artificial intelligence (AI) engine trained to match a current interest to a notification content (block 804). Method 800 includes determining whether at least one match is found (decision block 806). In response to determining that no match is found in decision block 806, method 800 includes discarding a second push notification of the one or more push notification that does not include notification content matching the at least one user interest subject (block 808). In an example, the number of promoted content items may be too numerous for presenting and curating for user interest enables prioritizing what promoted content is present. In another example, the number of promoted content items may not be too numerous present and curating for user interest may not be used to discard push notifications that do not match user interest. Then, method 800 ends.

In one or more embodiments, a push notification may not include an image, relying solely on textual information. According to aspects of the present disclosure, push notifications may include one or more image to more readily attract attention of a user and to more immediately convey meaning. In response to determining that the at least one match is found in decision block 806, method 800 includes searching the push notification for an image for each matching interest subject (block 810). Method 800 includes determining whether an image is found for each matching interest subject in the push notification (decision block 812). In response to determining that an image is not found for each matching interest subject in the push notification, method 800 includes searching one or more network source(s) for the image, based on a query associated with the match of the one or more user interest and the notification content (block 814). Method 800 includes downloading the image(s) identified by the search (block 816). In response to determining that an image is found for each matching interest subject in the push notification decision block 812 or after downloading the image(s) in block 816, method 800 proceeds to block 818 of FIG. 8B.

With reference to FIG. 8B, in response to determining that an image is found for each matching interest subject in the push notification in decision block 812 (FIG. 8A) or after downloading the image(s) in block 818 (FIG. 8B), method 800 includes determining whether there is more than one image corresponding to the more than one matching interest subject (decision block 818). In response to determining that there is more than one current interest matches respectively or one or more notification content, method 800 includes stitching together the more than one image into the notification image (block 820). In response to determining that there was not more than one image in decision block 818 or after performing image stitching in block 820, method 800 includes generating a personalized push notification comprising at least a portion of the first push notification and the notification image that corresponds to the at least one user interest that is matched to the notification content (block 822). Method 800 includes presenting the personalized push notification via at least one output device in lieu of the first push notification (block 824). Then method 800 ends.

According to aspects of the present disclosure, method 800 may include receiving, via a communications subsystem of an electronic device from a push notification source, one or more push notification, including a first push notification. Method 800 may include matching at least one user interest subject of one or more user interest subject in a personal knowledge base, which is stored in memory of the electronic device, to notification content contained in the first push notification. Method 800 may include generating a personalized push notification comprising at least a portion of the first push notification and a notification image that corresponds to the at least one user interest that is matched to the notification content.

In one or more embodiments, method 800 may further include presenting the personalized push notification via at least one output device in lieu of the first push notification. In one or more particular embodiments, method 800 may further include discarding a second push notification of the one or more push notification that does not include notification content matching the at least one user interest subject.

In one or more embodiments, method 800 may further include matching the one or more user interest subject from a group of user interest subjects comprising: (i) a person; (ii) an organization; (iii) a place; (iv) an object; (v) an activity; and (vi) an event. In one or more embodiments, method 800 may further include searching one or more network source for the image, based on a query associated with the match of the one or more user interest and the notification content. Method 800 may further include downloading the image identified by the search.

In one or more embodiments, in response to determining that more than one current interest matches respective one or more notification content, method 800 may further include searching one or more network source for more than one image corresponding to the more than one current interest. Method 800 may further include stitching together the more than one image into the notification image. In one or more embodiments, method 800 may further include matching the at least one user interest subject of one or more user interest subject in the personal knowledge base to the notification using an artificial intelligence (AI) engine trained to match a current interest to a notification content.

According to aspects of the present disclosure, the electronic device 100 (FIG. 1A), method 800 (FIG. 8), and computer program product, such as RSD 145 (FIG. 1A), provide techniques for curating push notifications presented by the electronic device to align with user interests to provide a better user experience. The electronic device is configured to learn user interests and preferences based on selections made by the user over time. Based on this knowledge, the electronic device analyzes proposed/received content to find aspects therein that would be of interest to the user if properly highlighted in a push notification. Unlike non-curated generic push notifications that may be overlooked by the user, the present disclosure provides the benefits of finding and highlighting a curated push notification aspects of the proposed content that are expected to be of interest to the user. The user interest may be based on a wide range of classifications such as topics, entities, events, locations, etc.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

1. An electronic device comprising:
a memory comprising (i) a personal knowledge base comprising one or more user interest subject; and (ii) a curated push notification module comprising an artificial intelligence (AI) engine trained to match a current interest to a notification content;
a communications subsystem that links the electronic device to a push notification source; and
a processor communicatively coupled to the memory and the communications subsystem, and which is configured to cause the electronic device to:
receive, via the communications subsystem from the push notification source, one or more push notification, including a first push notification;
match, using the AI engine, at least one user interest subject of the one or more user interest subject in the personal knowledge base to notification content contained in the first push notification;
identify a personalized textual heading in the first push notification based on the at least one user interest subject matching at least a portion of the first push notification; and
generate a personalized push notification comprising the personalized textual heading and a notification image that corresponds to the at least one user interest that is matched to the notification content.

2. The electronic device of claim 1, further comprising at least one output device communicatively coupled to the processor, and wherein the processor is further configured to cause the electronic device to:
present the personalized push notification via the at least one output device in lieu of the first push notification.

3. The electronic device of claim 1, wherein the processor is further configured to cause the electronic device to:
discard a second push notification of the one or more push notification that does not include notification content matching the at least one user interest subject.

4. The electronic device of claim 1, wherein the processor is further configured to cause the electronic device to match the one or more user interest subject from a group of user interest subjects comprising: (i) a person; (ii) an organization; (iii) a place; (iv) an object; (v) an activity; and (vi) an event.

5. The electronic device of claim 1, wherein the processor is further configured to cause the electronic device to:
search one or more network source for the image, based on a query associated with the match of the one or more user interest and the notification content; and
download the image identified by the search.

6. The electronic device of claim 1, wherein the processor is further configured to cause the electronic device to:
in response to determining that more than one current interest matches respective one or more notification content:
search one or more network source for more than one image corresponding to the more than one current interest; and
stitch together the more than one image into the notification image.

7. (canceled)

8. A method comprising:
receiving, via a communications subsystem of an electronic device from a push notification source, one or more push notification, including a first push notification;
matching at least one user interest subject of one or more user interest subject in a personal knowledge base, stored in memory of the electronic device, to notification content contained in the first push notification the matching completed using an artificial intelligence (AI) engine trained to match a current interest to a notification content;
identifying, using the AI engine, a personalized textual heading in the first push notification based on the at least one user interest subject matching at least a portion of the first push notification; and
generating a personalized push notification comprising the personalized textual heading and a notification image that corresponds to the at least one user interest that is matched to the notification content.

9. The method of claim 8, further comprising:
presenting the personalized push notification via at least one output device in lieu of the first push notification.

10. The method of claim 9, further comprising:
discarding a second push notification of the one or more push notification that does not include notification content matching the at least one user interest subject.

11. The method of claim 8, further comprising matching the one or more user interest subject from a group of user interest subjects comprising: (i) a person; (ii) an organization; (iii) a place; (iv) an object; (v) an activity; and (vi) an event.

12. The method of claim 8, further comprising:
searching one or more network source for the image, based on a query associated with the match of the one or more user interest and the notification content; and
downloading the image identified by the search.

13. The method of claim 8, further comprising:
in response to determining that more than one current interest matches respective one or more notification content:
searching one or more network source for more than one image corresponding to the more than one current interest; and
stitching together the more than one image into the notification image.

14. (canceled)

15. A computer program product comprising:
a computer readable storage device; and
program code on the computer readable storage device that when executed by a processor associated with an electronic device, the program code is configured to cause the electronic device to provide functionality of:
receiving, via a communications subsystem of the electronic device from a push notification source, one or more push notification, including a first push notification;
matching at least one user interest subject of one or more user interest subject in a personal knowledge base, which is stored in memory of the electronic device, to notification content contained in the first push notification, the matching completed using an artificial intelligence (AI) engine trained to match a current interest to a notification content;
identifying, using the AI engine, a personalized textual heading in the first push notification based on the at least one user interest subject matching at least a portion of the first push notification; and
generating a personalized push notification comprising the personalized textual heading and a notification image that corresponds to the at least one user interest that is matched to the notification content.

16. The computer program product of claim 15, wherein the program code is further configured to cause the electronic device to provide functionality of:
presenting the personalized push notification via at least one output device in lieu of the first push notification.

17. The computer program product of claim 15, wherein the program code is further configured to cause the electronic device to provide functionality of:
discarding a second push notification of the one or more push notification that does not include notification content matching the at least one user interest subject.

18. The computer program product of claim 15, wherein the program code is further configured to cause the electronic device to provide functionality of:
matching the one or more user interest subject from a group of user interest subjects comprising: (i) a person; (ii) an organization; (iii) a place; (iv) an object; (v) an activity; and (vi) an event.

19. The computer program product of claim 15, wherein the program code is further configured to cause the electronic device to provide functionality of:
searching one or more network source for the image, based on a query associated with the match of the one or more user interest and the notification content; and
downloading the image identified by the search.

20. The computer program product of claim 15, wherein the program code is further configured to cause the electronic device to provide functionality of:
in response to determining that more than one current interest matches respective one or more notification content:
searching one or more network source for more than one image corresponding to the more than one current interest; and
stitching together the more than one image into the notification image.
